(19) United States
(12) Patent Application Publication
(10) Pub. No.: US 2026/0160591 A1
(43) Pub. Date: Jun. 11, 2026

(54) WEIGHING CUP STRUCTURE AND METHOD FOR MEASURING AMOUNT OF DISPENSED MATERIAL USING THE WEIGHING CUP STRUCTURE

(71) Applicant: HORNG TERNG AUTOMATION CO., LTD., Kaohsiung City (TW)

(72) Inventors: Yu-hsien WANG, Kaohsiung City (TW); Wen-jung HSU, Kaohsiung City (TW)

(21) Appl. No.: 19/339,342

(22) Filed: Sep. 25, 2025

(30) Foreign Application Priority Data
Dec. 10, 2024 (TW) 113147962

(51) Int. Cl. G01G 21/22; G01G 15/00

(52) U.S. Cl. CPC G01G 21/22; G01G 15/00

(57) ABSTRACT

The present invention provides a weighing cup structure and a method for measuring amount of dispensed material using the weighing cup structure. The weighing cup structure is adapted for a dispensing amount measurement device of a dispensing apparatus, for receiving the material to be measured. The weighing cup structure comprises a cup body and a material-receiving platform. The cup body defines an accommodating space, and the material-receiving platform projects from the accommodating space. The top surface of the material-receiving platform is planar and has surface roughness. Friction between the material and the top surface is greater than friction between the material and an inner wall of a dispensing needle of the dispensing apparatus. The present invention effectively solves the problem of residual material during dispensing, ensuring complete removal of the material and accurate deposition onto the material-receiving platform, thereby improving measurement accuracy.

### CROSS-REFERENCE TO RELATED APPLICATIONS

This application claims priority to Taiwan Application Serial Number 113147962, filed on December 10, 2024, which is incorporated herein by reference.

### FIELD OF INVENTION

The present invention relates to a weighing cup structure and its applications, and in particular to a weighing cup structure and its application method in dispensing amount measurement.

### BACKGROUND OF INVENTION

In general, adhesive materials used in semiconductor processes are typically stored in a refrigerated environment. Before use in dispensing or other processes, they must be taken out of refrigeration and allowed to stand for a period of time to reach an appropriate temperature. The viscosity of the adhesive continuously changes with temperature, and adhesives of different viscosities may remain inside the dispensing needle, causing variations in the dispensed amount. Therefore, prior to dispensing, it is necessary to calibrate the dispensed amount, and production processes can proceed only after this calibration is completed.

Specifically, calibration of the dispensed amount is usually performed by measuring the weight of the dispensed material. In theory, the intended dispensed amount should be achieved within a fixed dispensing time. However, changes in adhesive viscosity affect the flow rate, which in turn affects the amount dispensed per unit time. To account for variations in the adhesive, the dispensing time is typically adjusted based on weight measurement experiments in order to ensure that the dispensed amount meets the intended accuracy.

However, during dispensing amount measurement experiments, residual adhesives may remain at or around the outlet of the dispensing needle, and adhesion to the needle may also occur. Such residual adhesive can lead to inaccurate measurement results, thereby affecting the calibration of the dispensed amount and subsequent dispensing processes.

### SUMMARY OF INVENTION

One object of the present invention is to provide a weighing cup structure and a method for measuring the amount of dispensed material using the weighing cup structure, so as to solve the above-mentioned problems.

According to the aforementioned object, a weighing cup structure is provided. The weighing cup structure is adapted for a dispensing amount measurement device of a dispensing apparatus and configured to receive a material to be measured. The weighing cup structure comprises a cup body and a material-receiving platform. The cup body has an accommodating space. The material-receiving platform protrudes upwardly from the accommodating space. A top surface of the material-receiving platform is planar and has a surface roughness, and friction between the material to be measured and the top surface is greater than friction between the material to be measured and an inner wall of a dispensing needle of the dispensing apparatus.

According to an embodiment of the present invention, the weighing cup structure further comprises at least three support structures provided on a bottom surface of the cup body.

According to the aforementioned object, a method for measuring an amount of dispensed material using the aforementioned weighing cup structure is also provided. The method comprising: starting from an initial position on a top surface of the material-receiving platform, moving a dispensing needle along a predetermined direction while dispensing the material to be measured until the dispensing needle reaches a preset position, at which point the dispensing is stopped; and after stopping the dispensing, continuing to move the dispensing needle along the predetermined direction to a final position, so that residual material at an outlet of the dispensing needle is pulled onto the top surface of the material-receiving platform by friction resulting from the surface roughness of the top surface of the material-receiving platform, thereby leaving the residual material on the top surface.

According to an embodiment of the present invention, the dispensing needle moves from the preset position to the final position at a speed higher than its speed when moving from the initial position to the preset position.

According to an embodiment of the present invention, a speed of the dispensing needle moving from the initial position to the preset position, and a speed of the dispensing needle moving from the preset position to the final position, are determined based on a dispensing time, a distance between the initial position and the preset position, and a distance between the preset position and the final position.

According to an embodiment of the present invention, a distance between the dispensing needle and the top surface of the material-receiving platform is less than or equal to an inner diameter of the dispensing needle.

According to an embodiment of the present invention, during movement of the dispensing needle from the initial position to the final position, a distance between the dispensing needle and the top surface of the material-receiving platform remains constant.

According to an embodiment of the present invention, during movement of the dispensing needle from the initial position to the final position, the moving direction remains unchanged.

According to an embodiment of the present invention, a distance between the initial position and the preset position is from 40% to 60% of a width of the top surface of the material-receiving platform.

According to an embodiment of the present invention, a sum of a distance between the initial position and the preset position and a distance between the preset position and the final position is less than a width of the top surface of the material-receiving platform.

According to the aforementioned embodiments of the present invention, the present invention provides a weighing cup structure and a method for measuring dispensed material using the same, effectively addressing residual material at or around the needle outlet or adhering to the needle during dispensing. By continuing the movement of the dispensing needle after dispensing stops and utilizing the surface roughness of the material-receiving platform to generate friction, residual material is drawn out onto the platform, ensuring complete removal and precise deposition. This minimizes residual material and enhances dispensing accuracy.

### DESCRIPTION OF DRAWINGS

FIG. 1 is a schematic view of a weighing cup structure according to an embodiment of the present invention.

FIG. 2 is another schematic view of the weighing cup structure according to an embodiment of the present invention.

FIG. 3 is a flowchart of a method for measuring a dispensed material amount using the weighing cup structure according to an embodiment of the present invention.

FIGS. 4A-4C are schematic diagrams Illustrating each step of the method for measuring a dispensed material amount using the weighing cup structure according to an embodiment of the present invention.

### DETAILED DESCRIPTION OF PREFERRED EMBODIMENTS

In order to make the above and other objects, features, and advantages of the present invention more comprehensible, preferred embodiments of the present invention will be described below in detail together with the attached drawings. Furthermore, the directional terms used in the present invention, for example, up, down, top, bottom, front, back, left, right, inside, outside, side, around, central, horizontal, transverse, vertical, longitudinal, axial, radial direction, the uppermost layer, or the lowermost layer, etc. are only the directions shown in the attached drawings. Therefore, the directional terms are only used to illustrate and express the present invention, but not to limit the present invention.

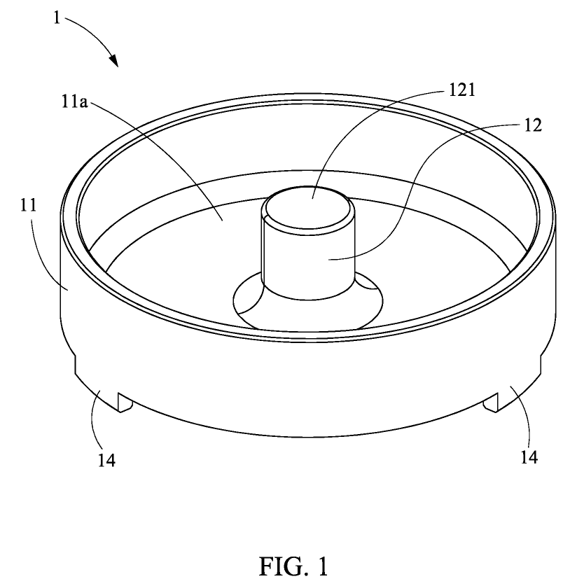

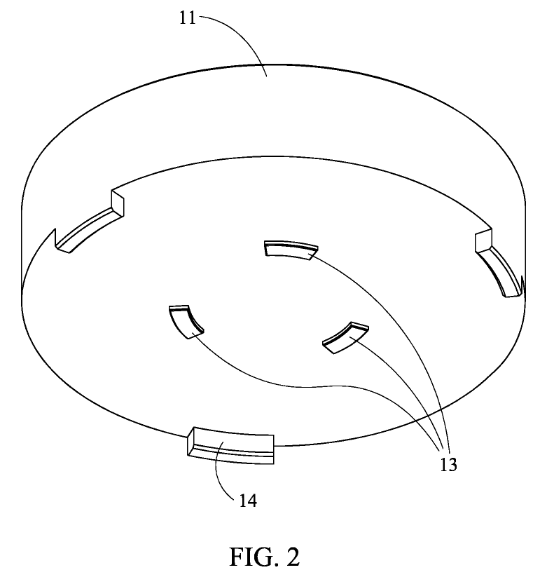

Referring to FIG. 1 and FIG. 2, the present embodiment provides a weighing cup structure 1. The weighing cup structure 1 is mainly applied to a dispensing amount measurement device, such as that used in a dispensing apparatus. Specifically, the weighing cup structure 1 is configured to be placed on a measuring unit of the dispensing amount measurement device, for receiving the dispensed material to be measured. In the present embodiment, the weighing cup structure 1 includes a cup body 11 and a material-receiving platform 12. The cup body 11 defines an accommodating space 11a, from a bottom surface of which the material-receiving platform 12 protrudes. A top surface 121 of the material-receiving platform 12 is horizontal and planar, and has a surface roughness. In the present embodiment, friction between the dispensed material and the top surface 121 of the material-receiving platform 12 is greater than friction between the dispensed material and an inner wall of a dispensing needle of the dispensing apparatus. In the present embodiment, the dispensed material may be adhesive material (glue) used in dispensing operations.

Specifically, the top surface 121 of the material-receiving platform 12 may be provided with a roughened surface, for example, through mechanical machining, sandblasting, chemical surface treatment, or other suitable methods. The friction between the dispensed material to be measured and an inner surface of the dispensing needle of the dispensing apparatus may be determined based on the viscosity of the dispensed material. The design in the present embodiment, where friction between the dispensed material to be measured and the top surface 121 of the material-receiving platform 12 is greater than friction between the dispensed material to be measured and the inner wall of the dispensing needle, facilitates smooth removal of the dispensed material from the dispensing needle, thereby preventing material residue from remaining in the dispensing needle. Specific operational procedures will be described in detail in subsequent sections. In the present embodiment, the cup body 11 is in the form of a hollow cylinder, and the material-receiving platform 12 is in the form of a cylinder; however, these shapes are not intended to limit the present invention. In other embodiments, the material-receiving platform 12 may be configured as a rectangular column or any other structure having a planar top surface.

In one embodiment, the weighing cup structure 1 further includes at least three support structures 13. The support structures 13 are disposed on a bottom surface of the cup body 11. In one example, the support structures 13 are arranged in a circular pattern, although the present invention is not limited thereto and other arrangements may be used. The support structures 13 function to stably secure the weighing cup structure 1 onto a platform of the dispensing amount measurement device, for example, by a three-point positioning arrangement. In another embodiment, the bottom outer edge of the weighing cup structure 1 further comprises protruding positioning structures 14, which allow the weighing cup structure 1 to be stably positioned on the platform of the dispensing amount measurement device. In one example, the positioning structures 14 are arranged in a circular pattern. The circle on which the support structures 13 are arranged is concentric with the circle on which the positioning structures 14 are arranged.

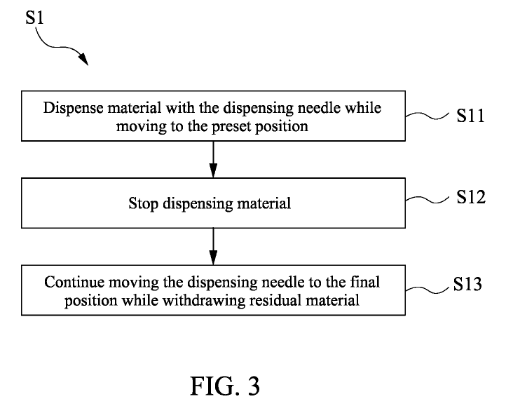

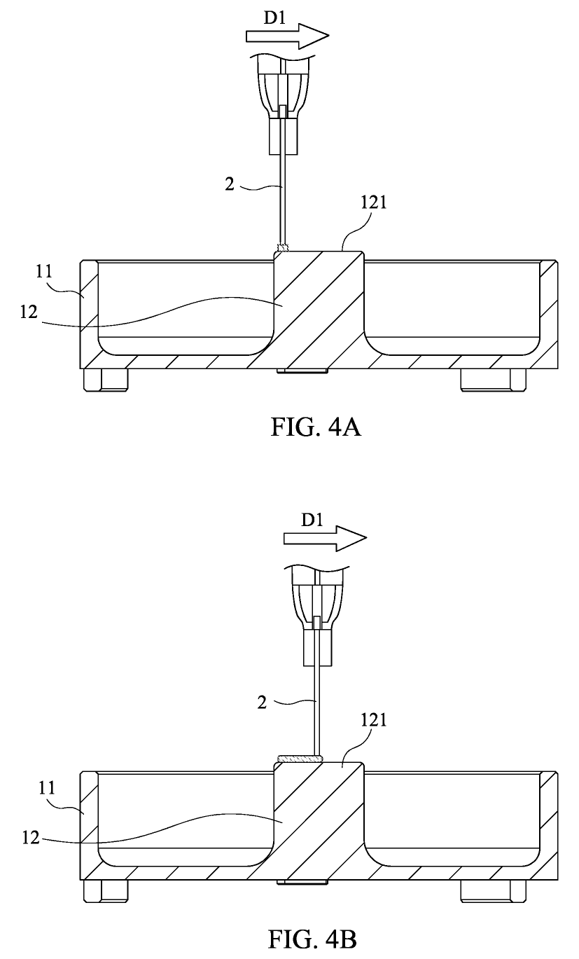

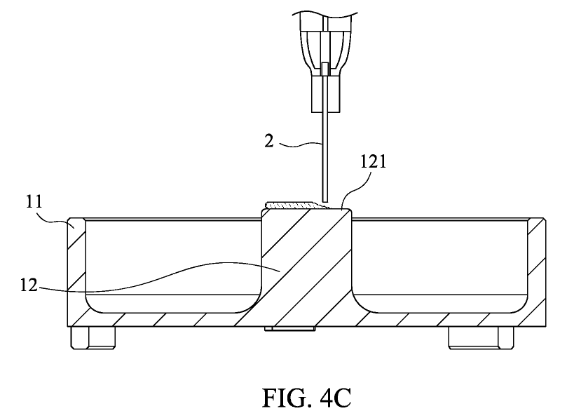

An embodiment of the present invention further provides a method S1 for measuring a dispensed material amount using the above-described weighing cup structure. Referring to FIG. 3 and FIGS. 4A-4C, the method S1 includes the following steps. First, in step S11, the dispensing needle 2 moves to a preset position while dispensing material. Specifically, as shown in FIG. 4A, in step S11, the dispensing needle 2 starts at an initial position on the top surface 121 of the material-receiving platform 12 and moves along a preset direction D1 while simultaneously dispensing material until reaching the preset position. Next, in step S12, the dispensing needle 2 stops dispensing material. Specifically, as shown in FIG. 4B, when the dispensing needle 2 reaches the preset position, material supply from the dispensing needle 2 is ceased. Then, in step S13, the dispensing needle 2 continues to move to a final position while withdrawing residual material. Specifically, as shown in FIG. 4B and FIG. 4C, after dispensing is stopped, the dispensing needle 2 continues to move along the preset direction D1 until reaching the final position. During this movement, residual material at the needle outlet is pulled onto the top surface 121 of the material-receiving platform 12 by friction generated from the surface roughness of the top surface 121.

During method S1, a predetermined distance should be maintained between the dispensing needle 2 and the material-receiving platform 12 to allow the material to be smoothly deposited on the platform. The required distance depends on the viscosity of the material, with higher-viscosity materials requiring a larger distance to ensure smooth dispensing. In a specific example, the distance may be set in the range of 0.2 mm to 1.5 mm.

As shown in FIGS. 4A-4C, in one embodiment, as the dispensing needle 2 moves from the initial to the final position, the distance between the dispensing needle 2 and the top surface 121 of the material-receiving platform 12 remains constant. That is, the dispensing needle 2 maintains a constant height throughout the movement, which ensures stable dispensing. In another embodiment, depending on the preset dispensing amount, dispensing needles 2 with different inner diameters may be selected, and the distance between the dispensing needle 2 and the top surface 121 of the material-receiving platform 12 is less than or equal to the inner diameter of the dispensing needle 2, which further facilitates stable dispensing.

In yet another embodiment, during the movement of the dispensing needle 2 from the initial position to the final position, the dispensing needle 2 maintains a constant movement direction. Even after dispensing is stopped, the dispensing needle 2 continues to move in the preset direction D1, consistent with its movement during the dispensing process, without any change in direction. This design utilizes the surface roughness of the top surface 121 of the material-receiving platform 12 to pull residual material from the outlet of the dispensing needle 2, preventing material from accumulating inside or at the outlet of the needle, thereby ensuring the accuracy of each operation. As shown in FIG. 4C, after the dispensing needle 2 reaches the final position, a tail end of the residual material drawn on the material-receiving platform 12 is thinner than the material dispensed during active dispensing. This occurs because dispensing has stopped, and as the dispensing needle 2 continues to move, residual material accumulated at the needle outlet is drawn onto the material-receiving platform 12, thereby preventing any residual material inside the dispensing needle 2.

In one embodiment, the speed of the dispensing needle 2 moving from the preset position to the final position is greater than its speed moving from the initial position to the preset position. That is, the dispensing needle 2 moves at a higher speed after dispensing is stopped than during dispensing, thereby helping to draw material from the dispensing needle 2. In designing the operation sequence, the moving speed of the dispensing needle 2 from the initial position to the preset position and from the preset position to the final position is calculated based on the dispensing time of the dispensing needle 2, the distance between the initial position and the preset position, and the distance between the preset position and the final position.

In the method S1 of the present embodiment, the initial position, preset position, and final position of the dispensing needle 2 can be designed according to requirements. The sum of the distance from the initial position to the preset position and the distance from the preset position to the final position should be less than the width of the top surface 121 of the material-receiving platform 12, to prevent the dispensing needle 2 from moving beyond the top surface 121. In this embodiment, the material-receiving platform 12 is cylindrical, and thus the “width” of the top surface 121 refers to its diameter; for other shapes of the material-receiving platform 12, the “width” may be defined as the extent of the top surface 121 along the preset direction D1. In one specific embodiment, the distance from the initial position to the preset position is designed to be 40% to 60% of the width of the top surface 121 of the material-receiving platform 12. That is, in step S11, the dispensing distance of the dispensing needle 2 corresponds to 40% to 60% of the width of the top surface 121, so that after dispensing is stopped, there remains sufficient length for the dispensing needle 2 to continue moving and deposit residual material, thereby effectively preventing material from remaining inside the needle. Moreover, since the distance from the initial position to the final position is limited by the width of the top surface 121, when a larger dispensing amount is required, the moving speed of the dispensing needle 2 should be reduced to extend the dispensing time (i.e., increase the dispensing duration), ensuring that the dispensed amount meets the predetermined requirement.

From the embodiments described above, the weighing cup structure provided by the present invention and the method for measuring dispensed material using the same can effectively solve problems such as residual material at or around the needle outlet or adhering to the needle during dispensing measurement. By continuing to move the dispensing needle after dispensing has stopped and utilizing the surface roughness of the material-receiving platform to create friction, residual material at the needle outlet is pulled out, ensuring complete removal and precise deposition onto the platform. This significantly reduces residual material and improves the accuracy of dispensing measurement, thus enabling more precise calibration of the dispensed material. Accordingly, the weighing cup structure of the present invention and its associated method help enhance the stability and consistency of subsequent dispensing processes, ultimately improving overall production efficiency and product quality.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims.

1. A weighing cup structure, adapted for a dispensing amount measurement device of a dispensing apparatus and configured to receive a material to be measured, wherein the weighing cup structure comprises:
a cup body having an accommodating space; and
a material-receiving platform protruding from the accommodating space, wherein a top surface of the material-receiving platform is planar and has a surface roughness, and wherein friction between the material and the top surface is greater than friction between the material and an inner wall of a dispensing needle of the dispensing apparatus.

2. The weighing cup structure according to claim 1, further comprising at least three support structures provided on a bottom surface of the cup body.

3. A method for measuring an amount of dispensed material using the weighing cup structure according to claim 1, comprising:
moving a dispensing needle from an initial position on a top surface of the material-receiving platform along a predetermined direction while dispensing the material, until the needle reaches a preset position, at which point dispensing stops; and
then moving the dispensing needle along the predetermined direction to a final position after dispensing stops, so that residual material an outlet of the dispensing needle is drawn onto the top surface by friction with the surface roughness, thereby leaving the residual material on the top surface.

4. The method according to claim 3, wherein the dispensing needle moves from the preset position to the final position at a speed greater than its speed when moving from the initial position to the preset position.

5. The method according to claim 3, wherein a speed of the dispensing needle moving from the initial position to the preset position, and a speed of the dispensing needle moving from the preset position to the final position, are determined based on a dispensing time, a distance between the initial position and the preset position, and a distance between the preset position and the final position.

6. The method according to claim 3, wherein a distance between the dispensing needle and the top surface of the material-receiving platform is less than or equal to an inner diameter of the dispensing needle.

7. The method according to claim 3, wherein during movement of the dispensing needle from the initial position to the final position, a distance between the dispensing needle and the top surface of the material-receiving platform remains constant.

8. The method according to claim 3, wherein during movement of the dispensing needle from the initial position to the final position, the direction of movement remains unchanged.

9. The method according to claim 3, wherein a distance between the initial position and the preset position is from 40% to 60% of a width of the top surface of the material-receiving platform.

10. The method according to claim 3, wherein a sum of a distance between the initial position and the preset position and a distance between the preset position and the final position is less than a width of the top surface of the material-receiving platform.
